(19) United States
(12) Patent Application Publication
(10) Pub. No.: US 2026/0154217 A1
(43) Pub. Date: Jun. 4, 2026

(54) INTELLIGENCE PROCESSING UNIT AND DATA DIMENSION EXPANDING METHOD THEREOF

(71) Applicant: SigmaStar Technology Ltd., Xiamen (CN)

(72) Inventor: Jun REN, Shanghai (CN)

(21) Appl. No.: 19/387,977

(22) Filed: Nov. 13, 2025

(30) Foreign Application Priority Data
Dec. 3, 2024 (CN) 202411764435.3

(51) Int. Cl. G06F 13/28

(52) U.S. Cl. CPC G06F 13/28; G06F 2213/28

(57) ABSTRACT

A data dimension expanding method includes the operations of: reading input tile data of input tensor data from a memory and storing the input tile data to a register of an intelligence processing unit; and copying the input tile data along a first dimension of the input tile data in the register according to a size of output tile data of output tensor data to generate first tile data, wherein a size of the first tile data is the same as the size of the output tile data, and the first tile data is utilized to perform an elementwise operation to generate the output tile data.

This application claims the benefit of China application Serial No. CN202411764435.3, filed on Dec. 3, 2024, the subject matter of which is incorporated herein by reference.

### BACKGROUND OF THE INVENTION

### Field of the Invention

The present application relates to an intelligence processing unit, and more particularly to an intelligence processing unit able to expand data in a high-speed register and a data expanding method thereof.

### Description of the Related Art

Elementwise operation are common in fields of data processing and deep learning. In general, in order to correctly perform an elementwise operation, it is necessary for the dimensions of input data to be the same as the dimensions of output data. It the prior art, when the dimensions of input data are different from the dimensions of output data, a central processing unit (CPU) expands the input data in a main memory, such that the main memory is accessed multiple times within the period of data expanding and the overall system efficiency is reduced. Moreover, the main memory of the approach above also needs a greater storage space, which causes a significant increase in implementation costs of the main memory.

### SUMMARY OF THE INVENTION

In some embodiments, it is an object of the present application to provide an intelligent processing unit able to expand data in a high-speed register and a data expanding method thereof so as to improve the drawbacks of the prior art.

In some embodiments, an intelligent processing unit includes a register, a direct memory access (DMA) controller, a command control circuit and an operation circuit. The DMA controller obtains input tile data of input tensor data from a memory, and stores the input tile data to the register. The command control circuit copies the input tile data along a first dimension of the input tile data in the register according to a size of output tile data of output tensor data to generate first tile data, wherein a size of the first tile data is the same as the size of the output tile data. The operation circuit performs an elementwise operation by utilizing the first tile data to generate the output tile data.

In some embodiments, a data dimension expanding method performed by an intelligent processing unit includes the operations of: reading input tile data of input tensor data from a memory and storing the input tile data to a register of the intelligence processing unit; and copying the input tile data along a first dimension of the input tile data in the register according to a size of output tile data of output tensor data to generate first tile data, wherein a size of the first tile data is the same as the size of the output tile data, and the first tile data is utilized to perform an elementwise operation to generate the output tile data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a schematic diagram of an intelligent processing unit (IPU) according to some embodiments of the present application.

FIG. 2 shows a flowchart of related operations performed by the central processing unit (CPU) and the intelligence processing unit in FIG. 1 according to some embodiments of the present application.

FIG. 3 shows a schematic diagram of expanding an innermost dimension of input tile data according to some embodiments of the present application.

FIG. 4 shows a schematic diagram of expanding a second innermost dimension of input tile data according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

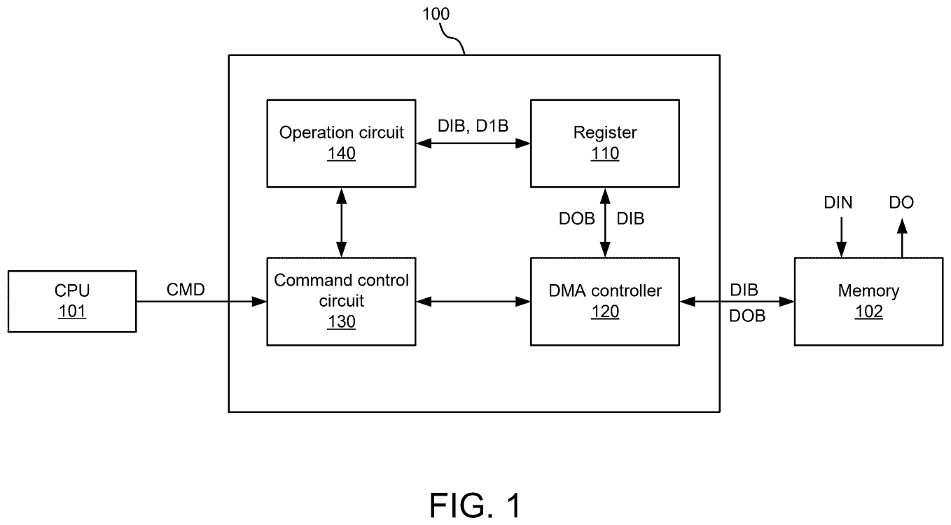

FIG. 1 shows a schematic diagram of an intelligent processing unit (IPU) 100 according to some embodiments of the present application. The intelligent processing unit 100 may execute multiple predetermined commands CMD issued by a central processing Unit (CPU) 101 to perform data expanding and an elementwise operation on input tensor data DIN to generate output tensor data DO.

The intelligent processing unit 100 includes a register 110, a direct memory access (DMA) controller 120, a command control circuit 130 and an operation circuit 140. In some embodiments, the register 110 may be a virtual memory, for example but not limited to, a high-speed memory. In some embodiments, the operation circuit 140 may be a vector core circuit. In some embodiments, the operation circuit 140 may include, for example but not limited to, a convolution processing circuit, a vector processing circuit, or a scaling processing circuit.

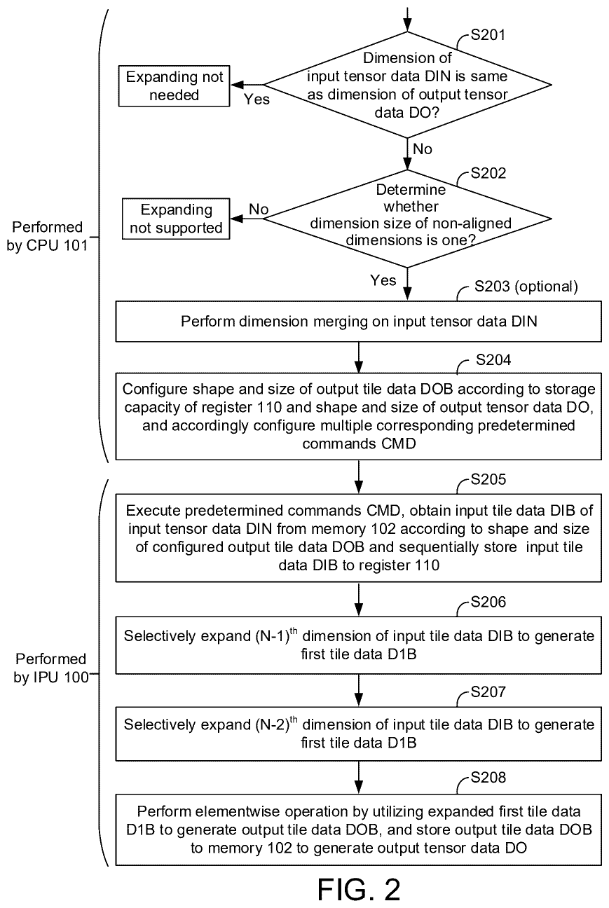

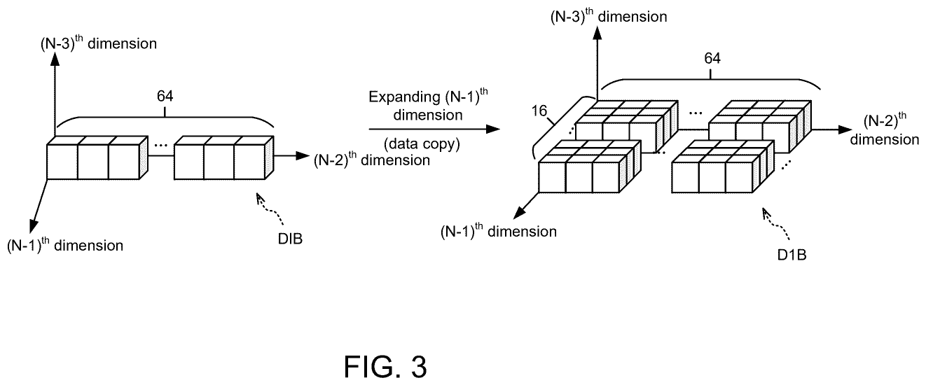

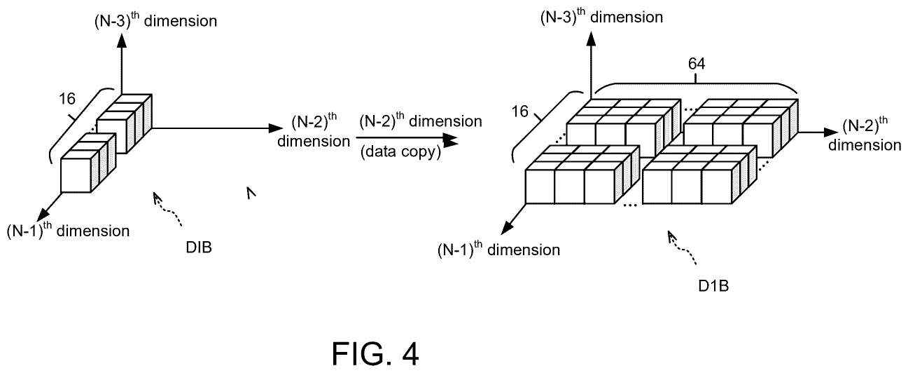

The DMA controller 120 is coupled to a memory 102 to obtain multiple sets of input tile data DIB of the input tensor data DIN from the memory 102, and sequentially store the multiple sets of input tile data DIB to the register 110. The command control circuit 130 copies the input tile data DIB along a first dimension of the input tile data DIB in the register 110 according to a size of output tile data DOB of output tensor data DO to generate first tile data D1B. In some embodiments, the first dimension may be, for example but not limited to, an outermost dimension and a second outermost dimension. Related operation details of the above are to be described with reference to FIG. 2, FIG. 3 and FIG. 4 below. The operation circuit 140 may perform an elementwise operation by utilizing the first tile data D1B to generate multiple sets of output tile data DOB, so as to sequentially output the multiple sets of output tile data DOB as the output tensor data DO. The DMA controller 120 may sequentially obtain the multiple sets of output tile data DOB from the register 110, and sequentially store the multiple sets of output tile data DOB obtained to the memory 102 to combine the multiple sets of output tile data DOB into the output tensor data DO.

In order to perform an elementwise operation, the shape and size of the input tensor data DIN are usually required to be consistent with the shape and size of the output tensor data DO. The shape and size of tensor data are usually defined by dimensions. For example, the size of the output tensor data DO may be represented as [3, 32, 256, 18], which indicates that the output tensor data DO is tensor data having four dimensions, wherein the outermost dimension is 3, the second outermost dimension is 32, the second innermost dimension is 256, and the innermost dimension is 18. For better illustration purposes, in the description below, the total number of dimensions of data are defined as N (sequentially, 0, 1, 2, . . . , N−3, N−2 and N−1, where N is 4 in continuation of the example above), wherein the 0^{th} dimension is the outermost dimension, the 1st dimension to the (N−3)th dimension are the second outermost dimensions, the (N−2)^{th} dimension is the second innermost dimension, and the (N−1)^{th} dimension is the innermost dimension. If the shape and size of the input tensor data DIN are inconsistent with the shape and size of the output tensor data DO, a central processing unit (CPU) 101 configures a corresponding instruction command CMD to expand the input tensor data DIN by the intelligence processing unit 100, allowing the elementwise operation to be correctly performed.

In actual applications, considering that the data capacity of the register 110 is rather limited, if the input tensor data DIN has a larger size, the DMA controller 120 is unable to completely store all of the input tensor data DIN in one round to the register 110 for further operation. Thus, the DMA controller 120 segments the input tensor data DIN into multiple sets of input tile data DIB, and sequentially stores the multiple sets of input tile data DIB one set after another to the register 110 for subsequent operations. Similarly, the operation circuit 140 also generates multiple sets of output tile data DOB one set after another, sequentially outputs the multiple sets of output tile data DOB as the output tensor data DO by the DMA controller 120, and stores the output tensor data DO to the memory 102. Thus, while the elementwise operation is performed, the shape and size of the input tile data DIB are also required to be consistent with the shape and size of the output tile data DOB.

In some embodiments, the CPU 101 may obtain the input tensor data DIN from the memory 102, and determine whether the shape and size of the input tensor data DIN are the same as the shape and size of the output tensor data DO. As such, the CPU 101 may accordingly determine whether the input tensor data DIN needs to be expanded, and if so, the CPU 101 accordingly divides the input tensor data DIN (that is, configuring the shape and size of the input tile data DIB) and configures multiple corresponding predetermined commands CMD, thus the intelligence processing unit 100 can execute the predetermined commands CMD to perform the multiple operations above. Related operation details are to be described with reference to the flowchart in FIG. 2 below.

FIG. 2 shows a flowchart of related operations performed by the CPU 101 and the intelligence processing unit (IPU) 100 in FIG. 1 according to some embodiments of the present application. Operation S201 to operation S204 are multiple operations performed by the CPU 101, and operation S205 to operation S208 are multiple operations performed by the intelligence processing unit 100.

In operation S201, it is determined whether dimensions of the input tensor data DIN are the same as the dimensions of the output tensor data DO. If so, it is determined that no expanding needs to be performed on the input tensor data DIN. If not, operation S202 is performed. For example, if the shape and size of the output tensor data DO are (3, 32, 256, 18) and the shape and size of the input tensor data DIN are (3, 32, 256, 18), the CPU 101 may determine that the dimensions of the input tensor data DIN are the same as dimensions of the output tensor data DO. On the other hand, if the shape and size of the output tensor data DO are (3, 32, 256, 18) and the shape and size of the input tensor data DIN are (3, 32, 256, 1), the CPU 101 may determine that the dimensions of the input tensor data DIN are different from the dimensions of the output tensor data DO (that is, the innermost dimensions of the two are different).

In operation S202, it is determined whether the dimension size of non-aligned dimension of the input tensor data DIN is 1. If not, it is determined expanding on the input tensor data DIN is not supported. If so, operation S203 is performed. For example, in the example above, the dimension size of the innermost dimension of the input tensor data DIN is 1. In this case, the CPU 101 may determine to expand the input tensor data DIN. On the other hand, if the dimension size of the innermost dimension is not 1, the CPU 101 may determine that expanding cannot be performed on the input tensor data DIN.

In operation S203, dimension merging is performed on the input tensor data DIN. For example, if the shape and size of a first input tensor data DIN to be processed are [1, 32, 256, 18], the shape and size of a second input tensor data DIN to be processed are [3, 32, 256, 1], and the shape and size of the output tensor data DO are [3, 32, 256, 18]. The three of the tensor data above have the same numbers of dimensions in the (N−3)^{th} dimension and the (N-2)^{th} dimension which are successive (that is, the dimension size of the (N−3)^{th} dimension is 32, and dimension size of the (N−2)^{th} dimension is 256). In this case, the CPU 101 may merge the (N−3)^{th} dimension and the (N−2)^{th} dimension, and the dimension size after they are merged is a product of the dimension sizes of the two which is 8192 (that is, 32×256). The shape and size of the first input tensor data DIN after merged are [1, 8192, 18], the shape and size of the second input tensor data DIN after merged are [3, 8192, 1], and the shape and size of the output tensor data DO after merged are [3, 8192, 18]. By dimension merging, the total number of dimensions of tensor data can be reduced to lower complexities of subsequent operations. In some embodiments, the operation S203 is an optional operation.

In operation S204, the shape and size of the output tile data DOB are configured according to a storage capacity of the register 110 and the shape and size of the output tensor data DO, and a plurality of corresponding predetermined commands CMD are accordingly configured.

In general, data arrangement of the tensor data is implemented in innermost (that is, the (N−1)^{th} dimension)-prioritized manner. Thus, the CPU 101 also configures the shape and size of the output tile data DOB in an innermost-prioritized manner. In some embodiments, the CPU 101 may configure the dimension size of each of the 0^{th} dimension to the (N−3)^{th} dimension of the output tile data DOB as 1, and configure the dimension sizes of the (N−2)^{th} dimension and the (N−3)^{th} dimension according to the storage capacity of the register 110. For example, the dimension size of the (N−1)^{th} dimension of the output tile data DOB may be the smaller between the storage capacity of the register 110 and the dimension size of the (N−1)^{th} dimension of the output tile data DOB, and may be represented as tile (N−1)=min(VR size, the dimension size of the (N−1)^{th} dimension), where tile (N−1) is the dimension size of the (N−1)^{th} dimension of the output tile data DOB, and VR size is the storage capacity of the register 110. The dimension size of the (N−2)^{th} dimension of the output tile data DOB may be the smaller between a predetermined ratio and the dimension size of the (N−2)^{th} dimension of the output tile data DOB, wherein the predetermined ratio is the storage capacity of the register 110 divided by the dimension size of the (N−1)^{th} dimension of the output tile data DOB. The dimension size of the (N−2)^{th} dimension of the output tile data DOB may be represented as tile(N−2)=min(VR size/tile(N−1), the dimension size of the (N−2)^{th} dimension), where tile(N−2) is the dimension size of the (N−2)^{th} dimension of the output tile data DOB, and VR size is the dimension size of the (N−2)^{th} dimension of the output tensor data DO.

For example, if the shape and size of the output tensor data DO after merging are [3, 6, 256, 16] and the storage capacity of the register 110 is 1024, the dimension size tile(N−1) of the (N−1)^{th} dimension of the output tile data DOB may be min(1024, 16)=16, and the dimension size tile(N−2) of the (N−2)^{th} dimension of the output tile data DOB may be min( 1024/16, 256)=64. Thus, it may be determined that the shape and size of the output tile data DOB are [1, 1, 64, 16].

In operation S205, the predetermined commands CMD are executed, and multiple sets of input tile data DIB of the input tensor data DIN are obtained from the memory 102 according to the shape and size of the configured output tile data DOB and sequentially stored to the register 110. For example, the intelligent processing unit 100 may execute the multiple predetermined commands CMD issued by the CPU 101, and read multiple sets of input tile data DIB from the memory 102 one set after another according to the shape and size of the output tile data DOB configured in step S204 to sequentially store the input tile data DIB to the register 110 so as to start an elementwise operation.

In operation S206, the (N−1)^{th} dimension of the input tile data DIB is selectively expanded to generate first tile data D1B. In some embodiments, the CPU 101 may determine beforehand between operation S201 and operation S203 whether the (N−1)^{th} dimension of the input tile data DIB needs to be expanded. If so, the CPU 101 may insert a corresponding data copy command into the multiple predetermined commands CMD, so that the intelligence processing unit 100 automatically expands the (N−1)^{th} dimension of the input tile data DIB upon executing the data copy command. Alternatively, in other embodiments, when the multiple predetermined commands CMD are executed, the intelligence processing unit 100 may determine whether to expand the (N−1)^{th} dimension of the input tile data DIB based on the dimension size of the (N−1)^{th} dimension of the input tile data DIB and the dimension size of the (N−1)^{th} dimension of the output tile data DOB.

To describe operation S206, refer to FIG. 3 showing a schematic diagram of expanding an innermost dimension (that is, the (N−1)^{th} dimension) of the input tile data DIB according to some embodiments of the present application. If the (N−1)^{th} dimension of the input tile data DIB needs to be expanded, it means that both of the dimension size of the (N−1)^{th} dimension of the input tensor data DIN and the dimension size of the (N−1)^{th} dimension of the input tile data DIB are 1. For example, the shape and size of the input tensor data DIN may be [d(0), d(1), . . . , d(n−3), d(n−2), 1], and the shape and size of the input tile data DIB may be [1, 1, . . . , 1, t(n−2), 1]. In this case, the command control circuit 130 may execute a data copy command among the multiple predetermined commands CMD to expand the shape and size of the input tile data DIB to be the same as the shape and size of the output tile data DOB, for example, which may be [1, 1, . . . , 1, t(n−2), t(n−1)]. For example, the shape and size of the output tensor data DO are [3, 6, 256, 16], the shape and size of the output tile data DOB are [1, 1, 64, 16], the shape and size of the input tensor data DIN are [3, 6, 256, 1], and the shape and size of the input tile data DIB are [1, 1, 64, 1]. In this case, as shown in FIG. 3, the command control circuit 130 may execute the data copy command above to copy the input tile data DIB multiple times along the (N−1)th dimension of the input tile data DIB in the register 110, wherein the number of the multiple times is the same as the dimension size (16 times in this example) of the (N−1)th dimension of the output tile data DOB, so as to generate the first tile data D1B. Thus, the shape and size of the first tile data D1B may be the same as those of the output tile data DOB, thus the operation circuit 140 may accordingly perform the elementwise operation. More specifically, in this example, the input tile data DIB includes 64 blocks of data (as the blocks shown in the drawing) in the (N−2)^{th} dimension, and after the copy operation above, the command control circuit 130 may generate 16×64 blocks of data and output these blocks of data as the first tile data D1B.

In some embodiments, the data copy command above may be, for example but not limited to, “vCopyElementbyX”, which is one of the commands executable by the intelligence processing unit 100 and has a function of copying all elements X times, where X is the 16 in the example above.

Again referring to FIG. 2, in operation S207, the (N−2)^{th} dimension of the input tile data DIB is selectively expanded to generate first tile data D1B. Similarly, in some embodiments, the CPU 101 may determine beforehand between operation S201 and operation S203 whether the (N−2)^{th} dimension of the input tile data DIB needs to be expanded. If so, the CPU 101 may insert a corresponding data copy command into the multiple predetermined commands CMD, so that the intelligence processing unit 100 automatically expands the (N−2)^{th} dimension of the input tile data DIB upon executing the data copy command. Alternatively, in other embodiments, when the multiple predetermined commands CMD are executed, the intelligence processing unit 100 may determine whether to expand the (N−2)^{th} dimension of the input tile data DIB based on the dimension size of the (N−2)^{th} dimension of the input tile data DIB and the dimension size of the (N−2)^{th} dimension of the output tile data DOB.

To describe operation S207, refer to FIG. 4 showing a schematic diagram of expanding a second innermost dimension (that is, the (N−2)^{th} dimension) of the input tile data DIB according to some embodiments of the present application. If the (N−2)^{th} dimension of the input tile data DIB needs to be expanded, it means that both of the dimension size of the (N−2)^{th} dimension of the input tensor data DIN and the dimension size of the (N−2)^{th} dimension of the input tile data DIB are 1. For example, the shape and size of the input tensor data DIN may be [d(0), d(1), . . . , d(n−3), 1, d(n-1)], and the shape and size of the input tile data DIB may be [1, 1, . . . , 1, 1, t(n−1)]. In this case, the command control circuit 130 may execute a data copy command among the multiple predetermined commands CMD to expand the shape and size of the input tile data DIB to be the same as the shape and size of the output tile data DOB, for example, which are [1, 1, ..., 1, t(n−2), t(n−1)]. For example, the shape and size of the output tensor data DO are [3, 6, 256, 16], the shape and size of the output tile data DOB are [1, 1, 64, 16], the shape and size of the input tensor data DIN are [3, 6, 1, 16], and the shape and size of the input tile data DIB are [1, 1, 1, 16]. In this case, as shown in FIG. 4, the command control circuit 130 may execute the data copy command above to copy the input tile data DIB multiple times along the (N−2)^{th} dimension of the input tile data DIB in the register 110, wherein the number of the multiple times is the same as the dimension size (64 times in this example) of the (N−2)^{th} dimension of the output tile data DOB, so as to generate the first tile data D1B. Thus, the shape and size of the first tile data D1B may be the same as those of the output tile data DOB, thus the operation circuit 140 can accordingly perform the elementwise operation. More specifically, in this example, the input tile data DIB includes 16 blocks of data (as the blocks shown in the drawing) in the (N−1)^{th} dimension, and after the copy operation above, the command control circuit 130 may generate 64×16 blocks of data and output these blocks of data as the first tile data D1B.

In some embodiments, the data copy command above may be, for example but not limited to, “vCopyNbyX”, which is one of the commands executable by the intelligence processing unit 100 and has a function of copying N elements X times, where N is the 16 and X is 64 in the example above.

Again referring to FIG. 2, in operation S208, an elementwise operation is performed by utilizing the first tile data D1B which has been expanded to generate the output tile data DOB, and the output tile data DOB is stored to the memory 102, so as to generate the output tensor data DO.

With the operations above, the shape and size of the first tile data D1B may be the same as the shape and size of the output tile data DOB. In this case, the operation circuit 140 may perform the elementwise operation by utilizing the first tile data D1B to generate the corresponding output tile data DOB. The operations above are repeated, and once all of the output tile data DOB has been generated, the DMA controller 120 may sequentially store the multiple sets of output tile data DOB from the register 110 to the memory 102 to combine the multiple sets of output tile data DOB into the output tensor data DO.

Since the CPU 101 configures the dimension size of each of the 0^{th} dimension to the (N−3)^{th} dimension of the output tile data DOB as 1, the dimension size of each (that is, one for each) of the 0^{th} dimension to the (N−3)^{th} dimension of the input tile data DIB is the same as that of each (that is, one for each) of the 0^{th} dimension to the (N−3)^{th} dimension of the output tile data DOB. Thus, the intelligence processing unit 100 does not need to expand the data for the 0^{th} dimension to the (N−3)^{th} dimension of the input tile data. More specifically, the dimension size (that is, one) of the outermost dimension (that is, the 0^{th} dimension) of the input tile data DIB is the same as the dimension size (that is, one) of the outermost dimension (that is, the 0^{th} dimension) of the output tile data DOB, and the dimension size (that is, one) of the second outermost dimension (for example, the (N−3)^{th} dimension) of the input tile data DIB is the same as the dimension size (that is, one) of the second outermost dimension (for example, the (N−3)^{th} dimension) of the output tile data DOB. As such, for the x^{th} dimension (where x is any value between 0 and N−3) of the input tile data DIB, the operation circuit 140 may perform the elementwise operation by repeatedly utilizing the same input tile data DIB in the x^{th} dimension, without needing to perform data expanding on the input tile data DIB.

In some related art, when an elementwise operation of different dimensions is performed, a CPU may insert a tile operator before input tensor data that need to be expanded, so as to copy the input tensor data in a main memory to thereby implement data expanding. However, multiple rounds of data access and data copy operation on the main memory cause reduced overall processing efficiency, and the storage space needed by the main memory is also significantly increased, leading to an overly increase in implementation costs of the main memory. Different from the prior art above, the command control circuit 130 copies data of the input tile data DIB multiple times in the register 110, and this is equivalent to expand the input tile data DIB. In other words, in some embodiments of the present application, the data expanding operation is performed in the register 110 (instead of the memory 102) which has a high-speed access ability, thereby improving the overall processing efficiency as well as reducing implementation costs of the memory 102. Thus, the intelligence processing unit 100 is able to improve the processing efficiency of expanding tensor data and reduce implementation costs, hence bringing significant improvement on related application fields involving elementwise operations (for example, including but not limited to, related applications of machine learning, deep learning and/or neural networks).

In some embodiments, the data expanding method may be performed by, for example but not limited to, the intelligence processing unit 100 in FIG. 1.

In a first operation, input tile data of input tensor data is read from a memory, and the input tile data is stored to a register in an intelligence processing unit. In a second operation, the input tile data is copied along a first dimension of the input tile data in the register according to a size of output tile data of output tensor data to generate first tile data, wherein a size of the first tile data is the same as the size of the output tile data, and the first tile data is utilized to perform an elementwise operation to generate the output tile data.

Details associated with the multiple operations of the data expanding method 500 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders.

In conclusion, the intelligence processing unit and data expanding method provided according to some embodiments of the present application are able to perform high-speed data expanding in a register of the intelligence processing unit, thereby effectively reducing overall costs and significantly improving overall efficiency of data expanding and execution of elementwise operations.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An intelligence processing unit, comprising:
a register;
a direct memory access (DMA) controller, obtaining input tile data of input tensor data from a memory, and storing the input tile data to the register;
a command control circuit, copying the input tile data along a first dimension of the input tile data in the register according to a size of output tile data of output tensor data to generate first tile data, wherein a size of the first tile data is same as the size of the output tile data; and
an operation circuit, performing an elementwise operation by utilizing the first tile data to generate the output tile data.

2. The intelligence processing unit according to claim 1, wherein the first dimension comprises an innermost dimension or a second innermost dimension of the input tile data.

3. The intelligence processing unit according to claim 1, wherein when the first dimension is an innermost dimension of the input tile data, the command control circuit copies the input tile data a plurality of times along the first dimension, and the number of the plurality of times of copying is same as dimension size of an innermost dimension of the output tile data.

4. The intelligence processing unit according to claim 1, wherein when the first dimension is a second innermost dimension of the input tile data, the command control circuit copies the input tile data a plurality of times along the first dimension, and the number of the plurality of times of copying is same as dimension size of a second innermost dimension of the output tile data.

5. The intelligence processing unit according to claim 1, wherein dimension size of the first dimension is one.

6. The intelligence processing unit according to claim 1, wherein dimension size of an outermost dimension of the input tile data is same as dimension size of an outermost dimension of the output tile data.

7. The intelligence processing unit according to claim 1, wherein dimension size of a second outermost dimension of the input tile data is same as dimension size of a second outermost dimension of the output tile data.

8. The intelligence processing unit according to claim 1, wherein dimension size of an outermost dimension or a second outermost dimension of the input tile data is one.

9. The intelligence processing unit according to claim 1, wherein the command control circuit copies the input tile data in response to a data copy command, and the data copy command is generated by a central processing unit based on that dimension size of the first dimension of the input tensor data is different from that of the output tensor data are different, and the dimension size of the first dimension of the input tensor data is one.

10. A data expanding method, performed by an intelligence processing unit, the data expanding method comprising:
reading input tile data of input tensor data from a memory, and storing the input tile data to a register in the intelligence processing unit; and
copying the input tile data along a first dimension of the input tile data in the register according to a size of output tile data of output tensor data to generate first tile data, wherein a size of the first tile data is same as the size of the output tile data, and
performing an elementwise operation by utilizing the first tile data to generate the output tile data.
